(19) United States
(12) Patent Application Publication
(10) Pub. No.: US 2016/0138123 A1
(43) Pub. Date: May 19, 2016

(54) PRECIPITATION-HARDENED STAINLESS STEEL ALLOYS

(71) Applicant: Erwen Huang, Shanghai (CN)

(72) Inventor: Erwen Huang, Shanghai (CN)

(21) Appl. No.: 14/375,150

(22) PCT Filed: Aug. 8, 2013
(86) PCT No.: PCT/CN2013/081044

§ 371 Date: Jul. 29, 2014

(51) Int. Cl. C21D 6/02; C22C 38/60; C22C 38/50; C22C 38/48; C22C 38/46; F01D 5/28; C22C 38/42; C22C 38/06; C22C 38/04; C22C 38/02; C22C 38/00; C21D 6/00; C22C 38/44

(52) U.S. Cl. CPC C21D 6/02; C21D 6/004; C21D 6/005; C21D 6/008; C22C 38/60; C22C 38/50; C22C 38/48; C22C 38/46; C22C 38/44; C22C 38/42; C22C 38/06; C22C 38/04; C22C 38/02; C22C 38/008; C22C 38/007; C22C 38/002; C22C 38/001; F01D 5/28; F05D 2300/171

(57) ABSTRACT

Forged precipitation-hardened stainless steel alloys are provided. The forged precipitation-hardened stainless steel alloy can include, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, a carbide forming element in an amount of about 0.3% to about 0.8% and greater than about 8 times that of carbon, the balance iron, and incidental impurities. Generally, the carbide forming element is selected from the group consisting of titanium, zirconium, tantalum, and a mixture thereof.

### FIELD OF THE INVENTION

The subject matter disclosed herein relates generally to high strength stainless steels. More particularly, the subject matter disclosed herein generally relates to martensitic stainless steel alloys and related methods of manufacturing and use (e.g., in turbine rotating components).

### BACKGROUND OF THE INVENTION

The metal alloys used for rotating components of a gas turbine, particularly the compressor airfoils, including rotating and stationary blades, must have a combination of high strength, toughness, fatigue resistance and other physical and mechanical properties in order to provide the required operational properties of these machines. In addition, the alloys used must also have sufficient resistance to corrosion damage due to the extreme environments in which turbines are operated, including exposure to various ionic reactant species (e.g., various species that include chlorides, sulfates, nitrides and other corrosive species). Corrosion can also diminish the other necessary physical and mechanical properties, such as the high cycle fatigue strength, by initiation of surface cracks that propagate under the cyclic thermal and operational stresses associated with operation of the turbine.

Various high strength stainless steel alloys have been proposed to meet these and other requirements, particularly at a cost that permits their widespread use. In particular, precipitation hardenable, martensitic stainless steels have been proposed and used. While such precipitation hardenable, martensitic stainless steels have provided the corrosion resistance, mechanical strength and fracture toughness properties described and are suitable for use in rotating steam turbine components, these alloys are still known to be susceptible to both intergranular corrosion attack (IGA) and corrosion pitting phenomena. For example, stainless steel airfoils, such as those used in the compressors of industrial gas turbines, have shown susceptibility to IGA, stress corrosion cracking (SCC) and corrosion pitting on the surfaces, particularly the leading edge surface, of the airfoil. These are believed to be associated with various electrochemical reaction processes enabled by the airborne deposits, especially corrosive species present in the deposits and moisture from intake air on the airfoil surfaces. Electrochemically-induced intergranular corrosion attack (IGA) and corrosion pitting phenomena occurring at the airfoil surfaces can in turn result in cracking of the airfoils due to the cyclic thermal and operating stresses experienced by these components. High level of moisture can result from use of on-line water washing, fogging and evaporative cooling, or various combinations of them, to enhance compressor efficiency. Corrosive contaminants usually result from the environments in which the turbines are operating because they are frequently placed in highly corrosive environments, such as those near chemical or petrochemical plants where various chemical species may be found in the intake air, or those at or near ocean coastlines or other saltwater environments where various sea salts may be present in the intake air, or combinations of the above, or in other applications where the inlet air contains corrosive chemical species.

Due to the significant operational costs associated with downtime of an industrial gas turbine, including the cost of purchased power to replace the output of the turbine, as well as the cost of dismantling the turbine to effect repair or replacement of the airfoils and the repair or replacement costs of the airfoils themselves, enhancements of the IGA resistance or pitting corrosion resistance, or both, have a significant commercial value.

In view of the above, stainless steel alloys suitable for use in turbine airfoils, particularly industrial gas turbine airfoils, in the operating environments described and having improved resistance to IGA, or corrosion pitting, or preferably both, are desirable and commercially valuable, and provide a competitive advantage.

### BRIEF DESCRIPTION OF THE INVENTION

Aspects and advantages of the invention will be set forth in part in the following description, or may be obvious from the description, or may be learned through practice of the invention.

Forged precipitation-hardened stainless steel alloys are generally provided. In one embodiment, the forged precipitation-hardened stainless steel alloy includes (e.g., comprises, consists essentially of, or consists of), by weight, about 14.0% to about 16.0% chromium, about 6.0% to about 8.0% nickel, about 1.25% to about 1.75% copper, about 1.0% to about 2.0% molybdenum (e.g., about 1.5% to about 2.0% molybdenum), about 0.001% to about 0.05% carbon, a carbide forming element in an amount of about 0.3% to about 0.8% and greater than about 8 times that of carbon, the balance iron, and incidental impurities. In this embodiment, the carbide forming element is selected from the group consisting of titanium, zirconium, tantalum, and a mixture thereof (e.g., selected from the group consisting of titanium, zirconium, and tantalum).

For example, in one particular embodiment, the carbide forming element is titanium. In this embodiment, the forged precipitation-hardened stainless steel alloy can include about 0.3% to about 0.7% titanium, with titanium being present in an amount greater than about 25 times that of carbon.

In another embodiment, the carbide forming element is zirconium. In this embodiment, the forged precipitation-hardened stainless steel alloy can include about 0.3% to about 0.7% zirconium, with zirconium being present in an amount greater than about 8 times that of carbon.

In yet another embodiment, the carbide forming element is tantalum. In this embodiment, the forged precipitation-hardened stainless steel alloy can include about 0.4% to about 0.8% tantalum, with tantalum being present in an amount greater than about 12 times that of carbon.

The forged precipitation-hardened stainless steel alloy can further include, in particular embodiments, up to 1.0 percent manganese; up to 1.0 percent silicon; up to 0.1 percent vanadium; up to 0.1 percent tin; up to 0.030 percent nitrogen; up to 0.025 percent phosphorus; up to 0.005 percent sulfur; up to 0.05 percent aluminum; up to 0.005 percent silver; and up to 0.005 percent lead as the incidental impurities.

Such precipitation-hardened stainless steel alloys are particularly suitable for use in a turbine airfoil or other rotary turbine component.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross sectional side view of an exemplary gas turbine as may incorporate various embodiments of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

Improved precipitation hardened, martensitic stainless steel alloys are generally provided, along with methods of their manufacture and use. The precipitation hardened, martensitic stainless steel alloys exhibits improved IGA and pitting corrosion resistance, while retaining high mechanical strength and fracture toughness, through control of the alloy constituents and their relative amounts and an aging heat treatment. The alloys are highly resistant to IGA in known aqueous corrosion environments and to corrosion pitting and other generic corrosion mechanisms.

These alloys are generally characterized by a uniform martensite microstructure with dispersed hardening precipitate phases, including fine copper-rich precipitates, and about 10% by weight or less of reverted austenite, which in combination with certain chemistry and processing requirements yields the desired corrosion resistance, mechanical strength and fracture toughness properties for the alloy. In certain embodiments, the alloys exhibit an ultimate tensile strength in the solution and aged condition of at least about 140 ksi (about 965 MPa), and a Charpy impact toughness of at least about 50 ft-lb (about 69 J), and in one embodiment in excess of about 100 ft-lb (about 138 J).

In summary, it has been discovered that the inclusion of a carbide forming element, which is selected from the group consisting of titanium, zirconium, tantalum, and a mixture thereof, within the alloy at a relatively high level in relation to the amount of carbon present makes the alloy increasingly resistant to IGA. That is, the amount of the carbide forming element within the alloy is generally proportional to the amount of carbon in the alloy (e.g., greater than about 8 times the amount of carbon). Further, it has been determined that improvements to the IGA resistance by incorporation of the carbide forming element in the amounts relative to C indicated can be done while maintaining a desirable mechanical strength and fracture toughness, including a minimum ultimate tensile strength and a minimum Charpy V-notch toughness after solution and age heat treatments of greater than about 965 MPa and about 69 J, respectively.

In one embodiment, the forged precipitation-hardened stainless steel alloy includes, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, a carbide forming element in an amount of about 0.3% to about 0.8% and greater than about 8 times that of carbon, the balance iron, and incidental impurities. As stated, the carbide forming element is selected from the group consisting of titanium, zirconium, tantalum, and a mixture thereof. For example, the carbide forming element is, in one embodiment, selected from the group consisting of titanium, zirconium, and tantalum. For example, in one particular embodiment, the forged precipitation-hardened stainless steel alloy consists essentially of (e.g., consists of), by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, a carbide forming element in an amount of about 0.3% to about 0.8% and greater than about 8 times that of carbon, the balance iron, and incidental impurities.

Without wishing to be bound by any particular theory, it is believed that the carbide forming element (e.g., titanium, zirconium, and/or tantalum) serves to protect chromium in the intergranular region of the alloy by consuming carbon by itself. Thus, the intergranular region has a high chromium content (i.e., a chromium-rich intergranular region) to provide a high corrosion resistance to intergranular corrosion attack and corrosion pitting.

In one embodiment, the carbide forming element is titanium. The forged precipitation-hardened stainless steel alloy, in one particular embodiment, comprises about 0.3% to about 0.7% titanium and in an amount greater than about 25 times that of carbon. As such, the forged precipitation-hardened stainless steel alloy can include, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, about 0.3% to about 0.7% titanium, the balance iron, and incidental impurities; with titanium being present in an amount greater than about 25 times that of carbon. Titanium is a strong carbide forming element, stronger than niobium. As such, titanium protects chromium in the intergranular region of the ally by consuming carbon by itself (i.e., forming titanium carbide), leading to a high chromium content in the intergranular region of the alloy to provide a high corrosion resistance to intergranular corrosion attack and corrosion pitting.

In another embodiment, the carbide forming element is zirconium. The forged precipitation-hardened stainless steel alloy, in one particular embodiment, comprises about 0.3% to about 0.7% zirconium and in an amount greater than about 8 times that of carbon. As such, the forged precipitation-hardened stainless steel alloy can include, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, about 0.3% to about 0.7% zirconium, the balance iron, and incidental impurities; with zirconium is present in an amount greater than about 8 times that of carbon. Zirconium is a strong carbide forming element, stronger than niobium. As such, zirconium can protect chromium in the intergranular region of the ally by consuming carbon by itself (i.e., forming zirconium carbide), leading to a high chromium content in the intergranular region of the alloy to provide a high corrosion resistance to intergranular corrosion attack and corrosion pitting.

In yet another embodiment, the carbide forming element is tantalum. The forged precipitation-hardened stainless steel alloy, in one particular embodiment, comprises about 0.4% to about 0.8% tantalum and in an amount greater than about 12 times that of carbon. As such, the forged precipitation-hardened stainless steel alloy can include, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, about 0.4% to about 0.8% tantalum, the balance iron, and incidental impurities; with tantalum is present in an amount greater than about 12 times that of carbon. Tantalum is a strong carbide forming element, stronger than niobium. As such, tantalum can protect chromium in the intergranular region of the ally by consuming carbon by itself (i.e., forming tantalum carbide), leading to a high chromium content in the intergranular region of the alloy to provide a high corrosion resistance to intergranular corrosion attack and corrosion pitting.

In view of the above, the required constituents of the stainless steel alloys disclosed herein are chromium, nickel, copper, molybdenum, carbon, and a carbide forming element selected from the group consisting of titanium, zirconium, tantalum, and a mixture thereof. These constituents are present in amounts that ensure an essentially martensitic, age-hardened microstructure having about 10% or less by weight of reverted austenite. As in the Custom 450 stainless steel alloy (described in U.S. Pat. No. 3,574,601), copper is critical for forming the copper-rich precipitates required to strengthen the alloy. Notably, the alloy compositions disclosed herein employ a very narrow range for carbon content, even more narrow than that disclosed for the Custom 450 alloy.

Carbon is an intentional constituent of the alloys disclosed herein as a key element for achieving strength by a mechanism of solution strengthening in addition to the precipitation strengthening mechanism provided by precipitates. However, in comparison to other stainless steels such as Type 422 and Custom 450 (carbon content of 0.10 to 0.20 weight percent), carbon is maintained at impurity-type levels. The limited amount of carbon present in the alloy is stabilized with the carbide forming element so as not to form austenite and carefully limit the formation of reverted austenite to the amounts described herein. The relatively high ratio of carbide forming element to C is necessary to achieve the improvement in intergranular corrosion attack resistance and maintain a desired level of strength and fracture toughness. As disclosed herein, it is believed a relatively high content of carbide forming element (relative to carbon) promotes carbide formation of the other major carbides present in the alloy (e.g., chromium carbides, molybdenum carbides, etc.), and may also influence the precipitation reaction during aging heat treatment, as the ratios greater than about 8 (carbide forming element to carbon) have a markedly decreased propensity for sensitization to intergranular corrosion attack associated with the aging temperature of these alloys (i.e., sensitization to intergranular corrosion attack is not a function of aging temperature, or effects related to aging temperature are greatly reduced).

At such a ratio, the propensity to sensitization of the alloy is a function of aging temperature. For example, tensile strength and fracture toughness, including a UTS of at least about 965 MPa and a Charpy V-notch toughness of at least about 69 J, that are desirable for turbine compressor airfoils and many other applications, can be obtained by aging at a temperature of about 1000° F. to about 1100° F., and more particularly about 1020° F. to about 1070° F. (about 549° C. to about 576° C.); and even more particularly about 1040° F. to about 1060° F. (about 560° C. to about 571° C.), but that in addition IGA resistance is enhanced, such that these alloys are virtually immune to IGA regardless of the aging temperature, as described herein. Further, it has been discovered that a desirable microstructural morphology, particularly the presence of desirable phases and a desirable phase distribution, is realized, including an essentially martensitic microstructural morphology, with about 10% or less, by weight of the alloy, of reverted austenite, particularly adjacent to the grain boundaries, following aging heat treatments of about 1020° F. to about 1070° F. (about 549° C. to about 577° C.) for times in the range of about 4 to about 6 hours.

Chromium provides the stainless properties for the alloys disclosed herein, and for this reason a minimum chromium content of about 14 weight percent is required for these alloys. However, as discussed in U.S. Pat. No. 3,574,601, chromium is a ferrite former, and is therefore limited to an amount of about 16 weight percent in the alloy to avoid delta ferrite. The chromium content of the alloy must also be taken into consideration with the nickel content to ensure that the alloy is essentially martensitic. As discussed in U.S. Pat. No. 3,574,601, nickel promotes corrosion resistance and works to balance the martensitic microstructure, but also is an austenite former. The narrow range of about 6.0 to about 8.0 weight percent nickel serves to obtain the desirable effects of nickel and avoid austenite.

Molybdenum in the alloy also promotes the corrosion resistance of the alloy. In particular, the presence of Mo in amounts, by weight, greater than about 1.0% up to about 2.0% significantly increases the resistance of the alloys disclosed herein to pitting corrosion, rather than adversely affecting the resistance by producing increased amounts of delta Mo ferrite as had been previously believed. More particularly, incorporation of about 1.5 to about 2.0% by weight of Mo is particularly advantageous with regard to increasing the resistance of the alloys disclosed herein to pitting corrosion. This advantageous aspect of the alloys disclosed herein may be used separately to improve the pitting corrosion resistance only, or it may be used in combination with the relatively high ratios of the carbide forming element to carbon disclosed herein to increase the resistance of these alloys to both intergranular and pitting corrosion.

Use of Mo contents in the ranges disclosed in the exemplary embodiments of the alloy compositions disclosed herein produce martensitic microstructures that include ferrite in an amount of about 2% or less by weight. Forming of a ferrite phase (including delta ferrite) in the martensite base microstructure has a detriment to corrosion resistance of the alloys disclosed herein. However, the existence of ferrite, including delta ferrite in an amount of about 2% or less by weight, has a minimal effect on the corrosion resistance and mechanical properties of these alloys.

The addition of the carbide forming element and Mo in the amounts described herein may have a propensity to promote segregation in these alloys during solidification due to their high melting points. Such segregation is generally undesirable due to the negative effect of segregation on the phase distributions and alloy microstructure, e.g., a reduced propensity to form the desirable martensitic microstructure and an increased propensity to form ferrite or austenite, or a combination thereof. Therefore, a solution heat treatment is generally employed prior to aging to reduce the propensity for such segregation.

As stated, incidental impurities may also be present in the forged precipitation-hardened stainless steel alloy. The most common incidental impurities include Mn, Si, V, Sn, N, P, S, Al Ag and Pb, generally in controlled amounts of less than about 1% or less by weight of the alloy for any one constituent and less than about 2.32% in any combination. However, the embodiment of the alloy described may include other incidental impurities in amounts which do not materially diminish the alloy properties as described herein, particularly the resistance to intergranular corrosion attack and corrosion pitting, tensile strength, fracture toughness and microstructural morphologies described herein. For example, the incidental impurities may include, by weight, up to about 1.0% Mn, up to about 1.0% Si, up to about 0.1% V, up to about 0.1% Sn, up to about 0.03% N, up to about 0.025% P, up to about 0.005% S, up to about 0.05% Al, up to about 0.005% Ag, and up to about 0.005% Pb.

The use of a very limited amount of nitrogen within the alloy promotes an impact toughness as described herein. More particularly, nitrogen contents above about 0.03 weight percent will have an unacceptable adverse effect on the fracture toughness of the alloys disclosed herein.

Manganese and silicon are not required in the alloy, and vanadium, nitrogen, aluminum, silver, lead, tin, phosphorus and sulfur are all considered to be impurities, and their maximum amounts are to be controlled as described herein. However, both manganese, an austenite former, and silicon, a ferrite former, may be present in the alloy, and when present may be used separately or together at levels sufficient to adjust the balance of ferrite and austenite as disclosed herein along with the other alloy constituents that affect the formation and relative amounts of these phases. Silicon also provides segregation control when melting steels, including the stainless steel alloys disclosed herein.

A final important aspect of the alloys disclosed herein is the requirement for a tempering or aging heat treatment. This heat treatment together with the associated cooling of the alloy is the precipitation hardening heat treatment and is responsible for the development the distributed fine precipitation phases, including Cu-rich precipitates, and other aspects of the alloy microstructure that provide the desirable strength, toughness, corrosion resistance and other properties described herein. This heat treatment may be performed at a temperature from about 1000° F. to about 1100° F. (about 538° C. to about 593° C.) for a duration of at least about 4 hours, and more particularly for a time ranging from about 4 to about 6 hours. More particularly, an aging temperature in the range from about 1020° F. to about 1070° F. (about 549° C. to about 576° C.) may be used. Even more particularly, an aging temperature in the range from about 1040° F. to about 1060° F. (about 560° C. to about 571° C.) may be used. Otherwise, the stainless steel alloy can be processed by substantially conventional methods. For example, the alloy may be produced by electric furnace melting with argon oxygen decarburization (AOD) ladle refinement, followed by electro-slag remelting (ESR) of the ingots. Other similar melting practices may also be used.

A suitable forming operation may then be employed to produce bar stocks and forgings that have the shape of turbine airfoils. The alloy, including components formed therefrom, is then solution heat treated in the range from about 1850° F. to about 1950° F. (about 1010° C. to about 1066° C.) for about one to about two hours, followed by the age heat treatment described above. The age heat treatment may be performed at the temperatures and for the times disclosed herein in ambient or vacuum environments to achieve the desirable mechanical properties and corrosion resistance disclosed herein.

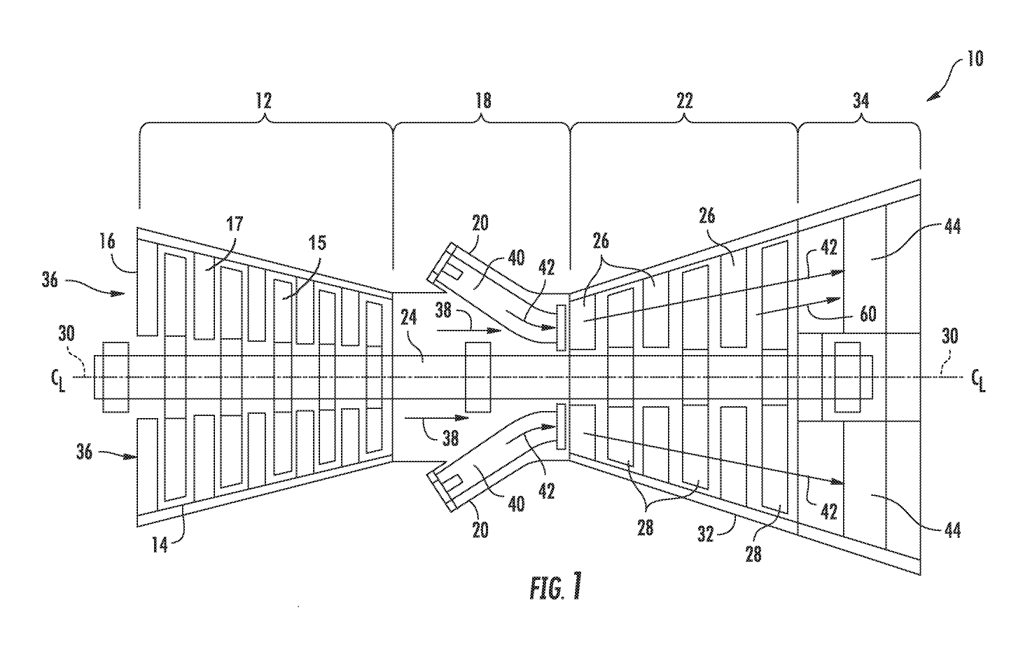

FIG. 1 illustrates an example of a gas turbine 10 as may incorporate the alloy described above in at least one component, particularly in forming turbine airfoil components. As shown, the gas turbine 10 generally includes a compressor section 12. The compressor section 12 includes a compressor 14 having a plurality of compressor blades 15 and stator vanes 17, with the compressor blades 15 attached to the shaft 24. The compressor includes an inlet 16 that is disposed at an upstream end of the gas turbine 10. The gas turbine 10 further includes a combustion section 18 having one or more combustors 20 disposed downstream from the compressor section 12. The gas turbine further includes a turbine section 22 that is downstream from the combustion section 18. A shaft 24 extends generally axially through the gas turbine 10. The turbine section 22 generally includes alternating stages of stationary nozzles 26 and turbine rotor blades 28 positioned within the turbine section 22 along an axial centerline 30 of the shaft 24. An outer casing 32 circumferentially surrounds the alternating stages of stationary nozzles 26 and the turbine rotor blades 28. An exhaust diffuser 34 is positioned downstream from the turbine section 22.

Generally, each compressor blade 15 and rotor blade 28 has a leading edge, a trailing edge, a tip, and a blade root, such as a dovetailed root that is adapted for detachable attachment to a turbine disk. The span of a blade extends from the tip edge to the blade root. The surface of the blade comprehended within the span constitutes the airfoil surface of the turbine airfoil. The airfoil surface is that portion of the turbine airfoil that is exposed to the flow path of air from the turbine inlet through the compressor section of the turbine into the combustion chamber and other portions of the turbine. While the alloys disclosed herein are particularly useful for use in turbine airfoils in the form of turbine compressor blades 15 and vanes 17, the alloys are broadly applicable to all manner of turbine airfoils used in a wide variety of turbine engine components. These include turbine airfoils associated with turbine compressor vanes and nozzles, shrouds, liners and other turbine airfoils, i.e., turbine components having airfoil surfaces such as diaphragm components, seal components, valve stems, nozzle boxes, nozzle plates, or the like. Also, while these alloys are useful for turbine rotor blades, they can potentially also be used for the turbine components of industrial gas turbines, including blades and vanes, steam turbine buckets and other airfoil components, aircraft engine components, oil and gas machinery components, as well as other applications requiring high tensile strength, fracture toughness and resistance to intergranular and pitting corrosion.

In operation, ambient air 36 or other working fluid is drawn into the inlet 16 of the compressor 14 and is progressively compressed to provide a compressed air 38 to the combustion section 18. The compressed air 38 flows into the combustion section 18 and is mixed with fuel to form a combustible mixture which is burned in a combustion chamber 40 defined within each combustor 20, thereby generating a hot gas 42 that flows from the combustion chamber 40 into the turbine section 22. The hot gas 42 rapidly expands as it flows through the alternating stages of stationary nozzles 26 and turbine rotor blades 28 of the turbine section 22.

Thermal and/or kinetic energy is transferred from the hot gas 42 to each stage of the turbine rotor blades 28, thereby causing the shaft 24 to rotate and produce mechanical work. The hot gas 42 exits the turbine section 22 and flows through the exhaust diffuser 34 and across a plurality of generally airfoil shaped diffuser struts 44 that are disposed within the exhaust diffuser 34. During various operating conditions of the gas turbine such as during part-load operation, the hot gas 42 flowing into the exhaust diffuser 34 from the turbine section 22 has a high level of swirl that is caused by the rotating turbine rotor blades 28. As a result of the swirling hot gas 42 exiting the turbine section 22, flow separation of the hot gas 42 from the exhaust diffuser struts occurs which compromises the aerodynamic performance of the gas turbine 10, thereby impacting overall engine output and heat rate. As shown in FIG. 1, the diffuser struts 44 are positioned relative to a direction of flow 60 of the hot gas 42 flowing from the turbine section 22 of the gas turbine 10.

It is to be understood that the use of “comprising” in conjunction with the alloy compositions described herein specifically discloses and includes the embodiments wherein the alloy compositions “consist essentially of” the named components (i.e., contain the named components and no other components that significantly adversely affect the basic and novel features disclosed), and embodiments wherein the alloy compositions “consist of” the named components (i.e., contain only the named components except for contaminants which are naturally and inevitably present in each of the named components).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A forged precipitation-hardened stainless steel alloy comprising, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, a carbide forming element in an amount of about 0.3% to about 0.8% and greater than about 8 times that of carbon, the balance iron, and incidental impurities;
wherein the carbide forming element is selected from the group consisting of titanium, zirconium, tantalum, and a mixture thereof.

2. The forged precipitation-hardened stainless steel alloy of claim 1, wherein the forged precipitation-hardened stainless steel alloy consists of, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, a carbide forming element in an amount of about 0.3% to about 0.8% and greater than about 8 times that of carbon, the balance iron, and incidental impurities.

3. The forged precipitation-hardened stainless steel alloy of claim 1, wherein the carbide forming element is selected from the group consisting of titanium, zirconium, and tantalum.

4. The forged precipitation-hardened stainless steel alloy of claim 1, wherein the carbide forming element is titanium.

5. The forged precipitation-hardened stainless steel alloy of claim 4, wherein the forged precipitation-hardened stainless steel alloy comprises about 0.3% to about 0.7% titanium, and wherein titanium is present in an amount greater than about 25 times that of carbon.

6. The forged precipitation-hardened stainless steel alloy of claim 1, wherein the carbide forming element is zirconium.

7. The forged precipitation-hardened stainless steel alloy of claim 6, wherein the forged precipitation-hardened stainless steel alloy comprises about 0.3% to about 0.7% zirconium, and wherein zirconium is present in an amount greater than about 8 times that of carbon.

8. The forged precipitation-hardened stainless steel alloy of claim 1, wherein the carbide forming element is tantalum.

9. The forged precipitation-hardened stainless steel alloy of claim 8, wherein the forged precipitation-hardened stainless steel alloy comprises about 0.4% to about 0.8% tantalum, and wherein tantalum is present in an amount greater than about 12 times that of carbon.

10. The forged precipitation-hardened stainless steel alloy of claim 1, wherein the alloy has a martensite microstructure and an ultimate tensile strength of at least about 965 MPa and Charpy V-notch toughness of at least about 69 J.

11. The precipitation-hardened stainless steel alloy of claim 1, wherein the alloy has an aged microstructure comprising martensite and not more than about 10% reverted austenite.

12. The precipitation-hardened stainless steel alloy of claim 1, further comprising: up to 1.0 percent manganese; up to 1.0 percent silicon; up to 0.1 percent vanadium; up to 0.1 percent tin; up to 0.030 percent nitrogen; up to 0.025 percent phosphorus; up to 0.005 percent sulfur; up to 0.05 percent aluminum; up to 0.005 percent silver; and up to 0.005 percent lead as the incidental impurities.

13. The precipitation-hardened stainless steel alloy of claim 1, wherein the precipitation-hardened stainless steel alloy comprises, by weight, about 1.5% to about 2.0% molybdenum.

14. The precipitation-hardened stainless steel alloy of claim 1, wherein the alloy comprises a turbine airfoil.

15. A forged precipitation-hardened stainless steel alloy comprising, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, about 0.3% to about 0.7% titanium, the balance iron, and incidental impurities; wherein titanium is present in an amount greater than about 25 times that of carbon.

16. The precipitation-hardened stainless steel alloy of claim 15, wherein the precipitation-hardened stainless steel alloy consists of, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, about 0.3% to about 0.7% titanium, the balance iron, and incidental impurities; wherein titanium is present in an amount greater than about 25 times that of carbon.

17. A forged precipitation-hardened stainless steel alloy comprising, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, about 0.3% to about 0.7% zirconium, the balance iron, and incidental impurities; wherein zirconium is present in an amount greater than about 8 times that of carbon.

18. The precipitation-hardened stainless steel alloy of claim 17, wherein the precipitation-hardened stainless steel alloy consists of, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, about 0.3% to about 0.7% zirconium, the balance iron, and incidental impurities; wherein zirconium is present in an amount greater than about 8 times that of carbon.

19. A forged precipitation-hardened stainless steel alloy comprising, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, about 0.4% to about 0.8% tantalum, the balance iron, and incidental impurities; wherein tantalum is present in an amount greater than about 12 times that of carbon.

20. The precipitation-hardened stainless steel alloy of claim 19, wherein the precipitation-hardened stainless steel alloy consists of, by weight, about 14.0% to about 16.0% chromium, about 6.0% to about 8.0% nickel, about 1.25% to about 1.75% copper, about 1.0% to about 2.0% molybdenum, about 0.001% to about 0.05% carbon, about 0.4% to about 0.8% tantalum, the balance iron, and incidental impurities; wherein tantalum is present in an amount greater than about 12 times that of carbon.
